(19) United States
(12) Patent Application Publication
(10) Pub. No.: US 2025/0305701 A1
(43) Pub. Date: Oct. 2, 2025

(54) Wireless Communication between HVAC Device and Smart Home System

(71) Applicant: Computime Limited, Hong Kong (HK)

(72) Inventor: Chi Lung Chan, Hong Kong (HK)

(21) Appl. No.: 18/958,184

(22) Filed: Nov. 25, 2024

Related U.S. Application Data
(60) Provisional application No. 63/570,278, filed on Mar. 27, 2024.

(51) Int. Cl. F24F 11/58; H04L 12/12

(52) U.S. Cl. CPC F24F 11/58; H04L 12/12

(57) ABSTRACT

A device in the home is connected to a home control system that includes a control system device in the home and one or more servers outside of the home. A device identifier of a device in a home is discovered using a mobile application of a mobile device when the mobile device is in the home. The device is configured to communicate wirelessly via a first protocol of one or more protocols. The device identifier is sent to a control system device in the home using the mobile application. The device identifier is sent through one or more servers in communication with the control system device using a wireless duplex server communication protocol. A control device identifier and an encryption key of the control system device are sent to the device using the mobile application using the first protocol when the mobile device is in the home.

### RELATED APPLICATIONS

This application claims the benefit of U.S. Provisional Patent Application Ser. No. 63/570,278, filed on Mar. 27, 2024, the content of which is incorporated by reference herein in its entirety.

### FIELD OF THE INVENTION

The teachings herein relate to controlling or monitoring a heating, ventilation, and air conditioning (HVAC) device via a smart home control system that is in communication with one or more cloud servers. More particularly the teachings herein relate to systems and methods for connecting a smart device in the home with a smart home control system that includes a control system device in the home and one or more servers outside of the home.

### BACKGROUND

Many smart home control systems are connected to one or more cloud servers. This allows the in-home devices designed to be connected to these smart home control systems to be monitored and controlled with a mobile application running on a smartphone outside of the home. For example, using the Google Home™ mobile application, one or more devices connected to an in-home Google Home™ device can be monitored and controlled outside of the home.

In addition, more and more devices used within a home are becoming smart devices like the devices designed specifically for smart home control systems. In other words, these devices include a processor and a wireless communication interface that allows these devices to be monitored and controlled remotely. The wireless communication interface provided with these devices typically includes duplex Bluetooth communication, duplex Wi-Fi communication, or both.

For most homeowners, it is desirable to be able to monitor and control as many of their smart home devices as possible using a single smart home control system. Using a single smart home control system greatly simplifies the management of smart home devices. Indeed, many smart home devices are already designed to be used with smart home control systems like Google Home™ or Alexa®.

Unfortunately, however, other smart home devices have a proprietary connection to their own one or more cloud servers that makes them accessible via their smartphone mobile application. Still, other smartphone devices are only accessible within the home using the local wireless communication interface provided.

In particular, many heating, ventilation, and air conditioning (HVAC) systems now include a wireless communication interface for monitoring and control. However, a large number of these HVAC systems are only accessible within the home using the wireless communication interface provided. In other words, they are not accessible to a smart phone application via one or more cloud servers of a smart home control system.

As a result, there is an unmet need for systems and methods that can make smart home devices, such as many smart HVAC systems, accessible outside of the home via a smart home control system that is in communication with one or more cloud servers.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2, is an exemplary diagram showing a system for connecting a smart home control system with an HVAC device in a home, in accordance with various embodiments.

FIG. 3 is an exemplary flowchart showing a method for connecting a device in the home to a home control system that includes a control system device in the home and one or more servers outside of the home, in accordance with various embodiments.

FIG. 4 is an exemplary flowchart showing a method for connecting to a home control system that includes a control system device in the home and one or more servers outside of the home, in accordance with various embodiments.

FIG. 5 is an exemplary flowchart showing a method for connecting to a device in a home, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

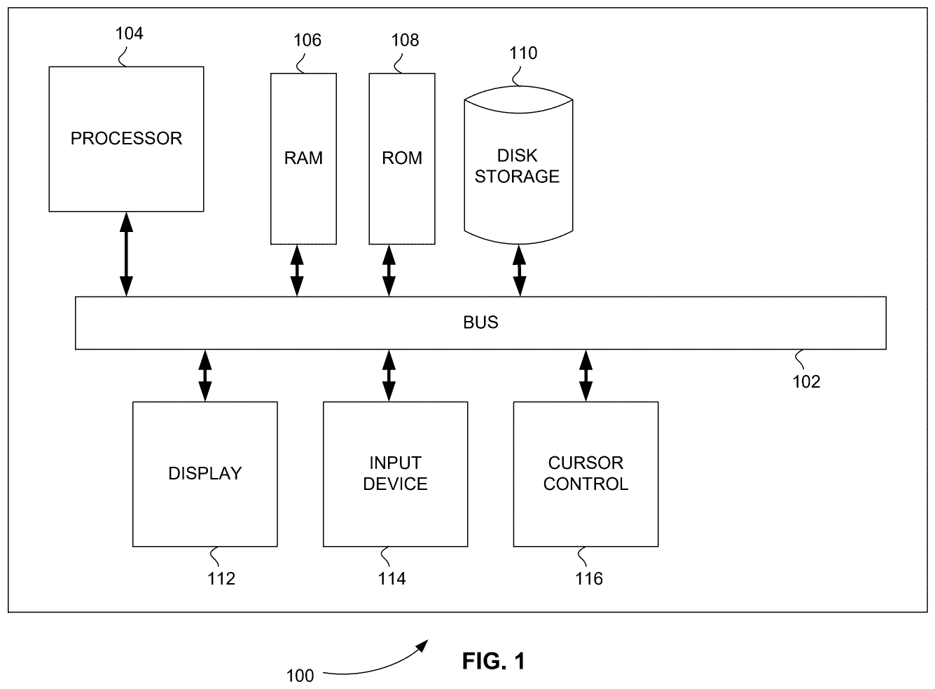

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random-access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein.

Alternatively, hard-wired circuitry may be used in place of or in combination with software instructions to implement the present teachings. For example, the present teachings may also be implemented with programmable artificial intelligence (AI) chips with only the encoder neural network programmed-to allow for performance and decreased cost. Thus, implementations of the present teachings are not limited to any specific combination of hardware circuitry and software.

The term “computer-readable medium” or “computer program product” as used herein refers to any media that participates in providing instructions to processor 104 for execution. The terms “computer-readable medium” and “computer program product” are used interchangeably throughout this written description. Such a medium may take many forms, including but not limited to, non-volatile media and volatile media. Non-volatile media includes, for example, optical or magnetic disks, such as storage device 110. Volatile media includes dynamic memory, such as memory 106.

Common forms of computer-readable media include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### HVAC Device Connection to Smart Home Control System

As described above, many smart home control systems are connected to one or more cloud servers. This allows home devices connected to these systems to be monitored and controlled with a mobile application running on a smartphone outside of the home.

In addition, more and more devices used within a home are becoming smart devices. For most homeowners, it is desirable to be able to monitor and control as many of their smart home devices as possible using a single smart home control system. Using a single smart home control system greatly simplifies the management of smart home devices.

Unfortunately, however, some smart home devices have a proprietary connection to their own one or more cloud servers that makes them accessible via their smartphone mobile application. Still, other smart home devices are only accessible within the home using the wireless communication interface provided. In particular, many heating, ventilation, and air conditioning (HVAC) systems now include a wireless communication interface for monitoring and control that is only accessible within the home.

As a result, there is an unmet need for systems and methods that can make smart home devices, such as many smart HVAC systems, accessible outside of the home via a smart home control system that is in communication with one or more cloud servers.

In various embodiments, an HVAC device of a home that only includes a wireless interest for communicating with devices in the home is connected to a smart home control system that allows access to the HVAC device outside of the home. The smart home control system includes a smart home control device in the home and one or more cloud servers located outside of the home in communication with the smart home control device. A mobile application running on a mobile device is used to obtain identifying information about the HVAC device when the mobile device is in the home. The mobile application sends the identifying information about the HVAC device to the smart home control device through the one or more cloud servers.

The mobile application also sends information about the smart home control device of the smart home control system to the HVAC device. Using this information, the HVAC device communicates with the smart home control device and sends the smart home control device a second copy of its identifying information. Using the identification information for the HVAC device that it receives from both the mobile application and the HVAC device itself, the smart home control device identifies the HVAC device and establishes a communication channel with the HVAC device to control and monitor the device.

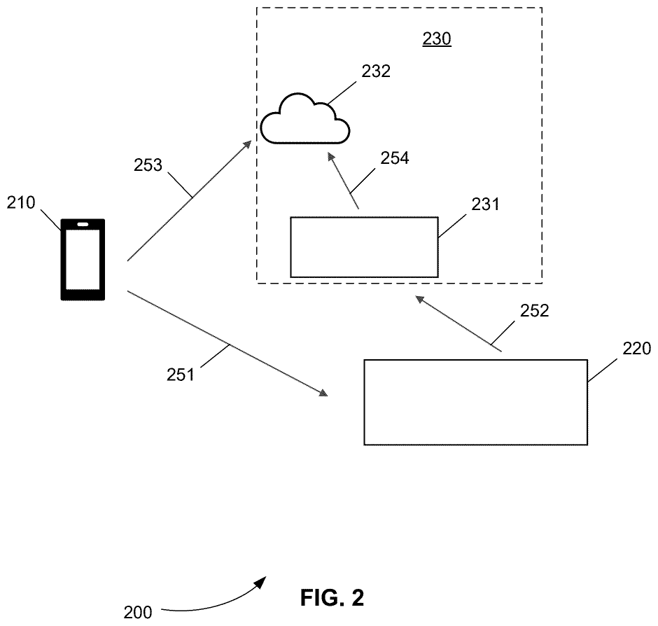

FIG. 2, is an exemplary diagram 200 showing a system for connecting a smart home control system with an HVAC device in a home, in accordance with various embodiments. FIG. 2 includes mobile device 210, HVAC device 220, and smart home control system 230. Smart home control system 230 includes smart home control device 231 and one or more cloud server computers 232 that are in communication with smart home control device 231.

Smart home control device 231 and HVAC device 220 are located in a home. One or more cloud server computers 232 are located outside of the home. Mobile device 210 can move between locations outside of the home and in the home.

Smart home control device 231 is in communication with one or more cloud server computers 232 using wireless communication, wired communication, or both wireless and wired communication. For example, smart home control device 231 can be connected wirelessly to a home networking system that, in turn, is connected through a wired connection to an Internet service provider (ISP) that allows communication with one or more cloud server computers 232 through the Internet. Smart home control devices can include, but are not limited, to Google Home™ devices, Alexa® devices, or home security base stations.

Mobile device 210 can be any type of computing device that includes a wireless communication interface, is capable of running mobile applications, and is capable of being easily moved between locations. Mobile device 210 can be, but is not limited to, a smartphone, laptop computer, tablet computer, or any type of computing device, such as the computer system of FIG. 1, that is mobile. A mobile application is, for example, a computer program capable of being executed on a mobile device.

HVAC device 220 can include, but is not limited to, a fan, an air conditioner, a heat pump, an oil or gas furnace, a coal furnace, or any type of heating or cooling device. HVAC device 220 includes a wireless communication interface for communicating with other devices in a home.

To connect HVAC device 220 to smart home control system 230, mobile device 210 attempts to wirelessly identify HVAC device 220 one mobile device 210 is in the home. In particular, mobile device 210 discovers a first device identifier of HVAC device 220. HVAC device 220 is configured to communicate wirelessly via one or more duplex wireless communication protocols. Using first protocol 251 of the one or more protocols, mobile device 210 discovers the first device identifier of HVAC device 220 when mobile device 210 is in the home.

Mobile device 210 then sends the first device identifier to home control device 231 in the home through one or more cloud server computers 232 in communication with home control device 231. In particular, mobile device 210 first sends the first device identifier to one or more cloud server computers 232 using wireless duplex cloud server communication protocol 253. Wireless duplex cloud server communication protocol 253 can be, but is not limited to, a cellular network protocol connected to the Internet that allows communication with one or more cloud server computers 232. This allows mobile device 210 to communicate with one or more cloud server computers 232 outside of the home. Alternatively, for example, wireless duplex cloud server communication protocol 253 can be, but is not limited to, a wireless protocol connected to the Internet being used within the home that allows communication with one or more cloud server computers 232.

After receiving the first device identifier from mobile device 210, one or more cloud server computers 232 send the first device identifier to home control device 231 using communication protocol 254 established between one or more cloud server computers 232 and home control device 231. Communications 254 protocol can also include, but is not limited to, a wireless protocol connected to the Internet being used within the home that allows communications between one or more cloud server computers 232 and home control device 231.

Finally, mobile device 210 sends a control device identifier and an encryption key of home control device 231 to HVAC device 220 from the mobile application of mobile device 210 using first protocol 251 when mobile device 210 is in the home. Mobile device 210 may have previously discovered the control device identifier and an encryption key by querying one or more cloud server computers 232 using wireless duplex cloud server communication protocol 253, for example.

When HVAC device 220 receives the control device identifier and the encryption key from mobile device 210, HVAC device 220 discovers home control device 231 using the control device identifier and second protocol 252 of the one or more protocols. Note that protocol labels 251, 252, 253, and 254 can also represent the communications channels established between devices using these protocols.

After discovering home control device 231, HVAC device 220 establishes encrypted wireless communications channel 252 with home control device 231 using the control device identifier, the encryption key, and second protocol 252.

In addition to receiving the first device identifier of the HVAC device 220 from mobile device 210, home control device 231 receives a second device identifier of HVAC device 220 from HVAC device 220 using encrypted wireless communications channel 252. Receiving identifiers of HVAC device 220 from two different sources allows home control device 231 to uniquely identify HVAC device 220.

In various embodiments, once home control device 231 uniquely identifies HVAC device 220 using the first device identifier and the second device identifier, home control device 231 controls and monitors HVAC device 220 using encrypted wireless communications channel 252.

In various embodiments, once home control device 231 controls and monitors HVAC device 220, home control device 231 allows HVAC device 220 to be controlled or monitored by one or more devices (not shown) outside of the home through communication access the one or more devices have to one or more cloud server computers 232.

In various embodiments, first protocol 251 includes Bluetooth and second protocol 252 includes Wi-Fi.

In various embodiments, first protocol 251 includes Wi-Fi and second protocol 252 includes Wi-Fi.

In various embodiments, the encryption key includes a symmetric encryption key.

In various embodiments, HVAC device 220 can be any smart device or device with wireless access located in the home. Devices with wireless access located in the home can include, but are not limited to, cameras, sensors, security devices, water heaters, appliances, thermostats, smoke or carbon monoxide detectors, water leak detectors, or sprinkler systems.

In various embodiments, one or more cloud server computers 232 can simply be one or more server computers.

### Mobile Device Method

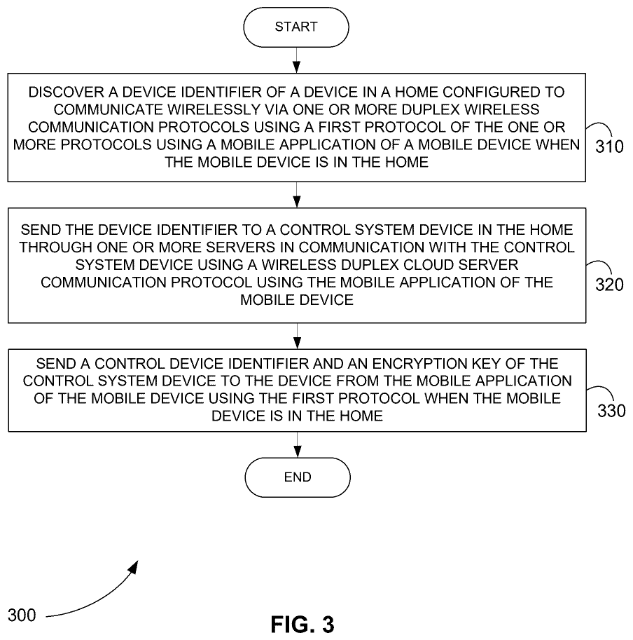

FIG. 3 is an exemplary flowchart showing a method 300 for connecting a device in the home to a home control system that includes a control system device in the home and one or more servers outside of the home, in accordance with various embodiments.

In step 310 of method 300, a device identifier of a device in a home is discovered using a mobile application of a mobile device when the mobile device is in the home. The device is configured to communicate wirelessly via one or more duplex wireless communication protocols using a first protocol of the one or more protocols.

In step 320, the device identifier is sent to a control system device in the home using the mobile application of the mobile device. The device identifier is sent through one or more servers in communication with the control system device using a wireless duplex server communication protocol.

In step 330, a control device identifier and an encryption key of the control system device are sent to the device using the mobile application of the mobile device using the first protocol when the mobile device is in the home.

### Smart Device Method

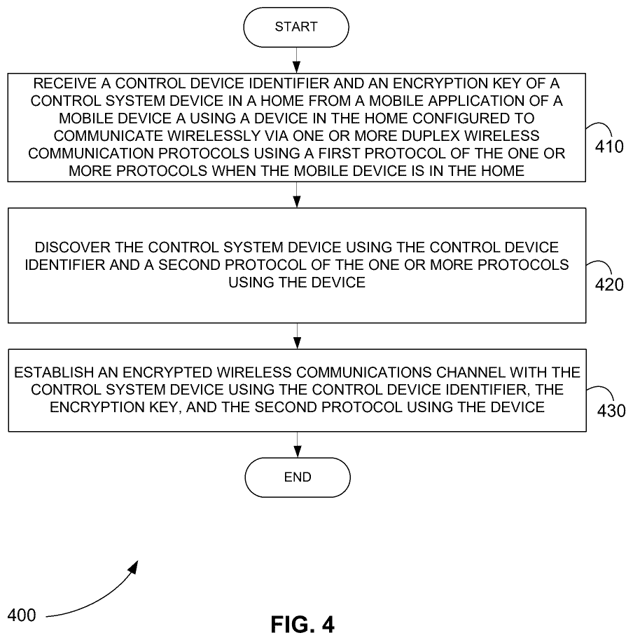

FIG. 4 is an exemplary flowchart showing a method 400 for connecting to a home control system that includes a control system device in the home and one or more servers outside of the home, in accordance with various embodiments.

In step 410 of method 400, a control device identifier and an encryption key of a control system device in a home are received from a mobile application of a mobile device when the mobile device is in the home using a device in the home. The device is configured to communicate wirelessly via one or more duplex wireless communication protocols and receives the device identifier and an encryption key using a first protocol of the one or more protocols.

The mobile device discovers a device identifier of the device using the first protocol and sends the device identifier to the control system device through one or more servers in communication with the control system device using a wireless duplex server communication protocol.

In step 420, the control system device is discovered using the control device identifier and a second protocol of the one or more protocols using the device.

In step 430, an encrypted wireless communications channel is established with the control system device using the control device identifier, the encryption key, and the second protocol using the device. Sending a control device identifier and an encryption key of the control system device to the device allows the device and the control system device to communicate.

In various embodiments, the device discovers the control system device using the control device identifier and a second protocol of the one or more protocols. The device establishes an encrypted wireless communications channel with the control system device using the control device identifier, the encryption key, and the second protocol. The device sends the device identifier to the control system device using the encrypted communication channel. The control system device identifies the device from the device identifier received from both the mobile application of the mobile device and the device. The control system device controls and monitors the device.

In various embodiments, the control system device allows the identified device to be controlled or monitored by one or more devices outside of the home through communication access the one or more devices have to the one or more servers in communication with the control system device.

### Control System Device Method

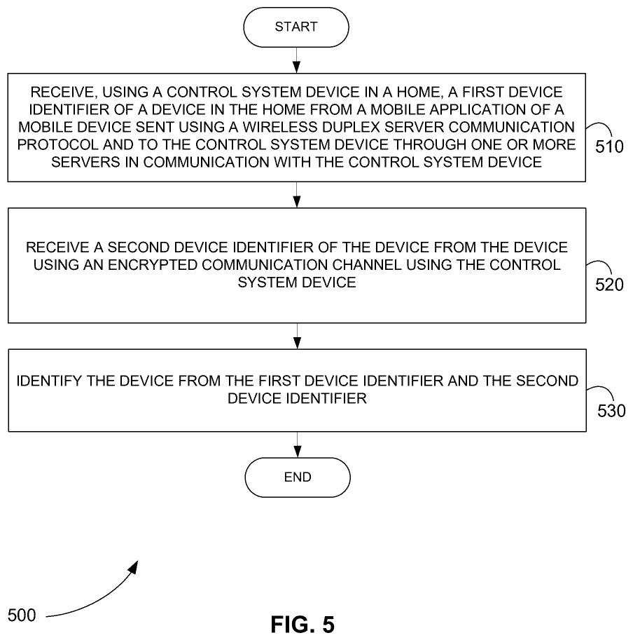

FIG. 5 is an exemplary flowchart showing a method 500 for connecting to a device in a home, in accordance with various embodiments.

In step 510 of method 500, using a control system device in a home, a first device identifier of a device in the home is received from a mobile application of a mobile device. The first device identifier is sent, using a wireless duplex server communication protocol, to the control system device through one or more servers in communication with the control system device.

The device is configured to communicate wirelessly via one or more duplex wireless communication protocols. When the mobile device is in the home, the mobile application of the mobile device discovers the first device identifier using a first protocol of the one or more protocols and sends a control device identifier and an encryption key of the control system device to the device using the first protocol. The device discovers the control system device using the control device identifier and a second protocol of the one or more protocols and establishes an encrypted wireless communications channel with the control system device using the control device identifier, the encryption key, and the second protocol.

In step 520, a second device identifier of the device is received from the device using the encrypted communication channel using the control system device.

In step 530, the device is identified from the first device identifier and the second device identifier.

In various embodiments, once identified, the device is controlled and monitored via the encrypted communication channel using the control system device.

In various embodiments, one or more devices outside of the home are allowed to control and monitor the device through communication access the one or more devices have to the one or more servers using the control system device.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A method for connecting a device in the home to a home control system that includes a control system device in the home and one or more servers outside of the home, comprising:
discovering a device identifier of a device in a home configured to communicate wirelessly via one or more duplex wireless communication protocols using a first protocol of the one or more protocols using a mobile application of a mobile device when the mobile device is in the home;
sending the device identifier to a control system device in the home through one or more servers in communication with the control system device using a wireless duplex server communication protocol and using the mobile application of the mobile device; and
sending a control device identifier and an encryption key of the control system device to the device using the mobile application of the mobile device using the first protocol when the mobile device is in the home.

2. The method of claim 1, wherein sending a control device identifier and an encryption key of the control system device to the device allows
the device to discover the control system device using the control device identifier and a second protocol of the one or more protocols,
the device to establish an encrypted wireless communications channel with the control system device using the control device identifier, the encryption key, and the second protocol,
the device to send the device identifier to the control system device using the encrypted communication channel,
the control system device to identify the device from the device identifier received from both the mobile application of the mobile device and the device, and the control system device to control and monitor the device.

3. The method of claim 2, wherein sending a control device identifier and an encryption key of the control system device to the device further allows
the control system device to allow the identified device to be controlled or monitored by one or more devices outside of the home through communication access the one or more devices have to the one or more servers in communication with the control system device.

4. The method of claim 1, wherein the first protocol comprises Bluetooth and the second protocol comprises Wi-Fi.

5. The method of claim 1, wherein the first protocol comprises Wi-Fi and the second protocol comprises Wi-Fi.

6. The method of claim 1, wherein the device comprises a heating, ventilation, and air conditioning (HVAC) system device.

7. The method of claim 1, wherein the wireless duplex server communication protocol comprises a cellular network protocol.

8. The method of claim 1, wherein the encryption key comprises a symmetric encryption key.

9. A method for connecting to a home control system that includes a control system device in the home and one or more servers outside of the home, comprising:
receiving a control device identifier and an encryption key of a control system device in a home from a mobile application of a mobile device using a device in the home configured to communicate wirelessly via one or more duplex wireless communication protocols using a first protocol of the one or more protocols when the mobile device is in the home,
wherein the mobile device discovers a device identifier of the device using the first protocol and sends the device identifier to the control system device through one or more servers in communication with the control system device using a wireless duplex server communication protocol;
discovering the control system device using the control device identifier and a second protocol of the one or more protocols using the device; and
establishing an encrypted wireless communications channel with the control system device using the control device identifier, the encryption key, and the second protocol using the device.

10. The method of claim 9, wherein establishing an encrypted wireless communications channel with the control system device allows
the device to send the device identifier to the control system device using the encrypted communication channel,
the control system device to identify the device from the device identifier received from both the mobile application of the mobile device and the device, and the control system device to control and monitor the device.

11. The method of claim 10, wherein establishing an encrypted wireless communications channel with the control system device further allows
the control system device to allow the identified device to be controlled or monitored by one or more devices outside of the home through communication access the one or more devices have to the one or more servers in communication with the control system device.

12. The method of claim 9, wherein the first protocol comprises Bluetooth and the second protocol comprises Wi-Fi.

13. The method of claim 9, wherein the first protocol comprises Wi-Fi and the second protocol comprises Wi-Fi.

14. The method of claim 9, wherein the device comprises a heating, ventilation, and air conditioning (HVAC) system device.

15. The method of claim 9, wherein the wireless duplex server communication protocol comprises a cellular network protocol.

16. The method of claim 9, wherein the encryption key comprises a symmetric encryption key.

17. A method for connecting to a device in a home, comprising:
receiving, using a control system device in a home, a first device identifier of a device in the home from a mobile application of a mobile device sent, using a wireless duplex server communication protocol, to the control system device through one or more servers in communication with the control system device,
wherein the device is configured to communicate wirelessly via one or more duplex wireless communication protocols,
wherein, when the mobile device is in the home, the mobile application of the mobile device discovers the first device identifier using a first protocol of the one or more protocols and sends a control device identifier and an encryption key of the control system device to the device using the first protocol, and
wherein the device discovers the control system device using the control device identifier and a second protocol of the one or more protocols and establishes an encrypted wireless communications channel with the control system device using the control device identifier, the encryption key, and the second protocol;
receiving a second device identifier of the device from the device using the encrypted communication channel using the control system device; and
identifying the device from the first device identifier and the second device identifier.

18. The method of claim 17, further comprising controlling and monitoring the device via the encrypted communication channel using the control system device.

19. The method of claim 18, further comprising allowing the device to be controlled or monitored by one or more devices outside of the home through communication access the one or more devices have to the one or more servers using the control system device.

20. The method of claim 17, wherein the device comprises a heating, ventilation, and air conditioning (HVAC) system device.
